(19) United States
(12) Patent Application Publication
(10) Pub. No.: US 2013/0314377 A1
(43) Pub. Date: Nov. 28, 2013

(54) OPTICAL TOUCH SENSOR APPARATUS

(71) Applicant: Oleg Los, Buffalo Grove, IL (US)

(72) Inventor: Oleg Los, Buffalo Grove, IL (US)

(21) Appl. No.: 13/481,485

(22) Filed: May 25, 2012

(51) Int. Cl. G06F 3/042

(52) U.S. Cl. 345/175

(57) ABSTRACT

Optical touch sensors are disclosed herein. An example optical touch sensor includes a plurality of optical transmitters arranged to emit light generally in a first direction and a plurality of optical receivers. At least one optical transmitter corresponds with each of the plurality of optical receivers. The sensor also includes an optical guide comprising a plurality of optical channels arranged in the first direction, where the optical guide provides a protective cover for the plurality of optical transmitters and the plurality of optical receivers.

### FIELD OF DISCLOSURE

The present disclosure relates to mobile devices, including but not limited to, optical touch sensor apparatus.

### BACKGROUND

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart phones, wireless personal digital assistants (PDAs), and laptop computers with wireless 802.11 or Bluetooth capabilities

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified based on the functions and operations being performed. With continued demand for decreased size of portable electronic devices, touch-sensitive displays continue to decrease in size.

Improvements in devices with touch-sensitive displays are desirable.

### BRIEF DESCRIPTION OF THE DRAWINGS

FIG. 1 is a block diagram of an example portable electronic device in accordance with the teachings of this disclosure.

FIG. 2 is an example portable electronic device of FIG. 1 implemented with an example optical sensor apparatus in accordance with the teachings of this disclosure.

FIG. 3 is cross-sectional view of an example optical sensor apparatus that may be used with the electronic devices of FIG. 1 or 2 in accordance with the teachings of this disclosure.

FIG. 4A is a plan view of the example optical sensor apparatus of FIG. 3 in accordance with the teachings of this disclosure configured to have a first shape.

FIG. 4B is a plan view of another example optical sensor apparatus of FIG. 3 configured to have a second shape in accordance with the teachings of this disclosure.

FIG. 4C is an enlarged view of a portion of the example optical sensor apparatus of FIG. 3, FIG. 4B and FIG. 4A in accordance with the teachings of this disclosure.

FIG. 5 is another plan view of the example optical sensor apparatus of FIG. 3, FIG. 4A and FIG. 4B in accordance with the teachings of this disclosure.

FIG. 6 is a cross-sectional view of another example optical sensor apparatus in accordance with the teachings of this disclosure.

FIG. 7 is a cross-sectional view of another example optical sensor apparatus in accordance with the teachings of this disclosure.

FIG. 8 is a cross-sectional view of another example optical sensor apparatus in accordance with the teachings of this disclosure.

FIG. 9 is an example portable electronic device implemented with an example optical sensor apparatus in accordance with the teachings of this disclosure.

FIG. 10 is an example portable electronic device implemented with another example optical sensor apparatus in accordance with the teachings of this disclosure.

FIG. 11 is an example portable electronic device implemented with another example optical sensor apparatus in accordance with the teachings of this disclosure.

### DETAILED DESCRIPTION

Example optical touch sensor apparatus disclosed herein facilitate provision of an input device and/or an output device having improved resolution and/or functionality (e.g., relatively high resolution navigation functionality). An example optical sensor apparatus described herein employs a touch-sensitive display (e.g., a liquid crystal display) embedded with one or more optical sensors to allow simultaneous information display and input sensing. For example, the display presents a key or keypad (e.g., a morphing keypad, a menu key, etc.) and the optical sensor(s) provides an input device to select a key associated with the keypad presented via the display. Additionally or alternatively, the example optical sensor apparatus disclosed herein provides navigation functionality. In particular, when used in place of navigation keys (e.g., a track ball), the optical sensor replaces known optical navigation modules (ONM).

More specifically, the optical sensor apparatus disclosed herein may include, for example, a plurality of optical transmitters arranged to emit light generally in a first direction and a plurality of optical receivers such that at least one optical transmitter corresponds with one of the optical receivers. An example plurality of optical transmitters disclosed herein may include or comprise at least one of a liquid crystal display (LCD), a light-emitting diode display, a backlight for a liquid crystal display, etc. A touch-sensitive panel may have an optical sensor apparatus disclosed herein integrated within each color pixel. For example, a touch sensitive panel or display may employ a plurality of transmitters including red, blue and green light emitting diodes (LEDs), an infrared (IR) LED, diode laser illumination source, vertical cavity surface emitting laser (VCSEL), etc., associated with an optical pixel. Thus, the example optical sensor apparatus disclosed herein may provide full color imaging (e.g., morphing applications for the menu keys).

The optical receivers may provide a high resolution optical input device, such as a navigation device to enable a user to input a command (e.g., scroll, point or otherwise use the navigation device as a trackpad). In some examples, an optical sensor apparatus disclosed herein provides a display and sensor assembly to enable a user to navigate a graphical user interface presented on a display in the electronic device via the optical sensor apparatus. The optical sensor may detect an input member. The optical sensor apparatus may be used for data entry, cursor control, scroll bar control on a display, etc. Further, the optical sensor apparatus may be used for fingerprint detection and/or activation.

Additionally or alternatively, an example optical sensor apparatus disclosed herein employs an optical guide to provide relatively high resolution navigation functionality. An example light guide disclosed herein includes one or more optical channels that transport, guide or emit light along the optical channels. For example, the optical guide transports a light from the optical transmitters to a sensing surface of the optical sensor apparatus. As a result, the example optical sensor apparatus provides, for example, a high resolution navigation pad (e.g., an X-Y track pad). Additionally or alternatively, the optical guide may be positioned over at least a portion (e.g., positioned on top) of the display to provide a display (e.g., a touch-sensitive display) having a first area that has a first resolution and a second area having a second resolution where the second area covered by the optical guide has a higher resolution than the first area.

Additionally or alternatively, the optical guide may include a protective cover for the display and/or the plurality of optical receivers, transmitters. In yet other examples, the optical guide can provide a protective cover for the display and/or the plurality of optical receivers or sensors and/or the transmitters. The protective cover protects the receivers or sensors and/or the transmitters from damage. In some examples, the cover and the optical guide may be formed as a unitary structure. As a result of employing the cover, the panel may be positioned behind the optical guide to provide a seamless display area with another display or touch-sensitive display. Further, the cover and/or optical guide may provide a privacy screen by enabling viewing of a display or touch-sensitive display in a direction along an axis substantially normal to the display. The example optical sensor apparatus disclosed herein may be employed with touch or touch-less displays or panels.

In some examples, the example optical sensor apparatus disclosed herein may provide haptic or tactile feedback in response to an object engaging the optical sensor apparatus. For example, the optical sensor apparatus may employ dome switches positioned underneath or above a display or panel. Additionally or alternatively, the example optical sensor apparatus disclosed herein may employ an accelerometer to identify a tapping (e.g., a user tapping) on the top of the optical guide. Additionally or alternatively, the example optical sensor apparatus disclosed herein may employ a touch sensor to identify an input member moving away from or approaching the optical guide. In some examples, pressure sensors (e.g., pressure sensing films) and/or piezoelectric elements positioned under the optical guide may be provided for sensing and/or tactile feedback.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

The disclosure generally relates to an electronic device, such as a portable electronic device or non-portable electronic device. Examples of portable electronic devices include mobile, or handheld, wireless communication devices such as pagers, cellular phones, cellular smart-phones, wireless organizers, personal digital assistants, wirelessly enabled notebook computers, tablet computers, mobile internet devices, electronic navigation devices, and so forth. The portable electronic device may be a portable electronic device without wireless communication capabilities, such as handheld electronic games, digital photograph albums, digital cameras, media players, e-book readers, and so forth. Examples of non portable electronic devices include desktop computers, electronic white boards, smart boards utilized for collaboration, built-in monitors or displays in furniture or appliances, and so forth.

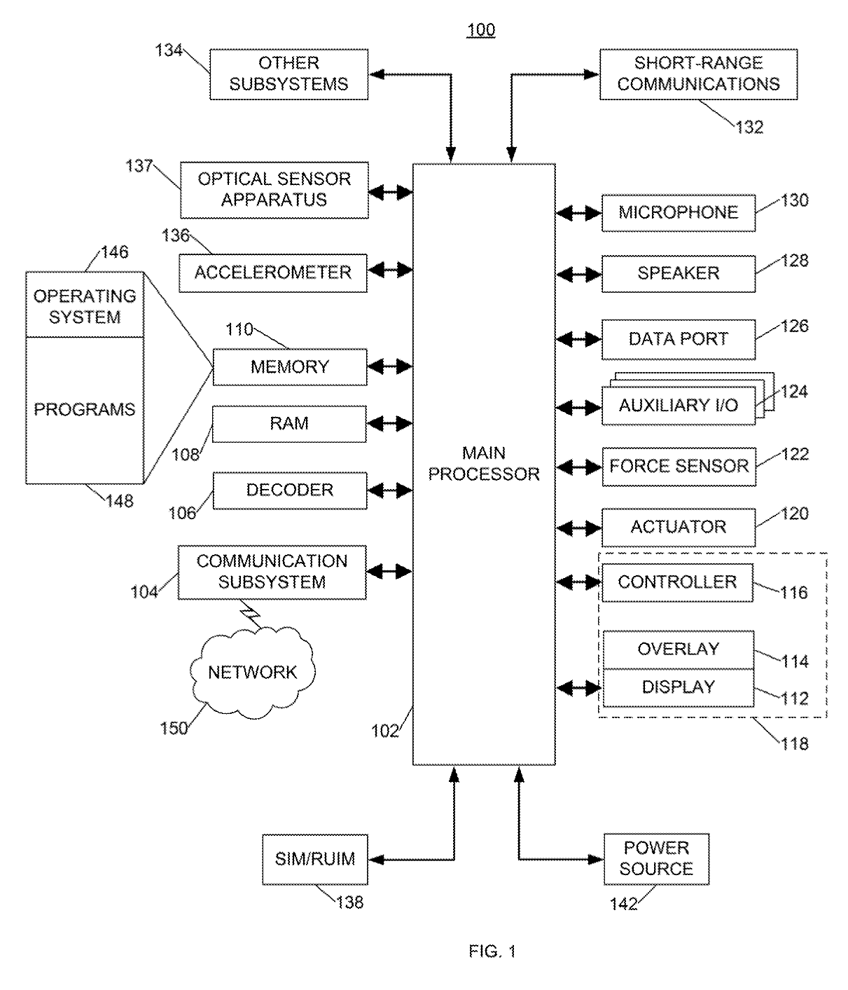

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as a Random Access Memory (RAM) 108, memory 110, a touch-sensitive display 118, one or more actuators 120, one or more force sensors 122, an auxiliary input/output (I/O) subsystem 124, a data port 126, a speaker 128, a microphone 130, short-range communications 132 and other device subsystems 134, and an optical sensor apparatus 137. The touch-sensitive display 118 includes a display 112 and touch sensors 114 that are coupled to at least one controller 116 that is utilized to interact with the processor 102. Input via a graphical user interface is provided via the touch-sensitive display 118. Information, such as text, characters, symbols, images, icons, and other items that may be displayed or rendered on a portable electronic device, is displayed on the touch-sensitive display 118 via the processor 102. The processor 102 may also interact with an accelerometer 136 that may be utilized to detect direction of gravitational forces or gravity-induced reaction forces.

To identify a subscriber for network access, the portable electronic device 100 may utilize a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software programs, applications, or components 148 that are executed by the processor 102 and are typically stored in a persistent, updatable store such as the memory 110. Additional applications or programs may be loaded onto the portable electronic device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth. A capacitive touch-sensitive display includes one or more capacitive touch sensors 114. The capacitive touch sensors may comprise any suitable material, such as indium tin oxide (ITO).

One or more touches, also known as touch contacts or touch events, may be detected by the touch-sensitive display 118 and/or the optical sensor apparatus 137. The processor 102 may determine attributes of the touch, including a location of the touch. Touch location data may include data for an area of contact or data for a single point of contact, such as a point at or near a center of the area of contact. The location of a detected touch may include x and y components, e.g., horizontal and vertical components, respectively, with respect to one's view of the touch-sensitive display 118 and/or the optical sensor apparatus 137. For example, the x location component may be determined by a signal generated from one touch sensor, and the y location component may be determined by a signal generated from another touch sensor. A touch may be detected from any suitable input member, such as a finger, thumb, appendage, or other objects, for example, a stylus (active or passive), pen, or other pointer, based on the nature of the touch-sensitive display 118. Multiple simultaneous touches may be detected.

One or more gestures may also be detected by the touch-sensitive display 118 and/or the optical sensor apparatus 137. A gesture, such as a swipe, also known as a flick, is a particular type of touch on a touch-sensitive display 118 and/or the optical sensor apparatus 137 and may begin at an origin point and continue to an end point, for example, a concluding end of the gesture. A gesture may be identified by attributes of the gesture, including the origin point, the end point, the distance travelled, the duration, the velocity, and the direction, for example. A gesture may be long or short in distance and/or duration. Two points of the gesture may be utilized to determine a direction of the gesture. A gesture may also include a hover. A hover may be a touch at a location that is generally unchanged over a period of time or is associated with the same selection item for a period of time.

The optional actuator(s) 120 may be depressed or activated by applying sufficient force to the touch-sensitive display 118 to overcome the actuation force of the actuator 120. The actuator(s) 120 may be actuated by pressing anywhere on the touch-sensitive display 118. The actuator(s) 120 may provide input to the processor 102 when actuated. Actuation of the actuator(s) 120 may result in provision of tactile feedback. When force is applied, the touch-sensitive display 118 is depressible, pivotable, and/or movable. Such a force may actuate the actuator(s) 120. The touch-sensitive display 118 may, for example, float with respect to the housing of the portable electronic device, i.e., the touch-sensitive display 118 may not be fastened to the housing. A mechanical dome switch actuator may be utilized. In this example, tactile feedback is provided when the dome collapses due to imparted force and when the dome returns to the rest position after release of the switch. Alternatively, the actuator 120 may comprise one or more piezoelectric (piezo) devices that provide tactile feedback for the touch-sensitive display 118.

Optional force sensors 122 may be disposed in conjunction with the touch-sensitive display 118 to determine or react to forces applied to the touch-sensitive display 118. The force sensor 122 may be disposed in line with a piezo actuator 120. The force sensors 122 may be force-sensitive resistors, strain gauges, piezoelectric or piezoresistive devices, pressure sensors, quantum tunneling composites, force-sensitive switches, or other suitable devices. Force as utilized throughout the specification, including the claims, refers to force measurements, estimates, and/or calculations, such as pressure, deformation, stress, strain, force density, force-area relationships, thrust, torque, and other effects that include force or related quantities. Optionally, force information related to a detected touch may be utilized to select information, such as information associated with a location of a touch. For example, a touch that does not meet a force threshold may highlight a selection option, whereas a touch that meets a force threshold may select or input that selection option. Selection options include, for example, displayed or virtual keys of a keyboard; selection boxes or windows, e.g., “cancel,” “delete,” or “unlock”; function buttons, such as play or stop on a music player; and so forth. Different magnitudes of force may be associated with different functions or input. For example, a lesser force may result in panning, and a higher force may result in zooming.

The touch-sensitive display 118 includes a display area in which information may be displayed, and a non-display area extending around the periphery of the display area. The display area generally corresponds to the area of the display 112. Information is not displayed in the non-display area by the display, which non-display area is utilized to accommodate, for example, electronic traces or electrical connections, adhesives or other sealants, and/or protective coatings around the edges of the display area. The non-display area may be referred to as an inactive area and is not part of the physical housing or frame of the electronic device. Typically, no pixels of the display are in the non-display area, thus no image can be displayed by the display 112 in the non-display area. Optionally, a secondary display, not part of the primary display 112, may be disposed under the non-display area. Touch sensors may be disposed in the non-display area, which touch sensors may be extended from the touch sensors in the display area or distinct or separate touch sensors from the touch sensors in the display area. A touch, including a gesture, may be associated with the display area, the non-display area, or both areas. The touch sensors may extend across substantially the entire non-display area or may be disposed in only part of the non-display area.

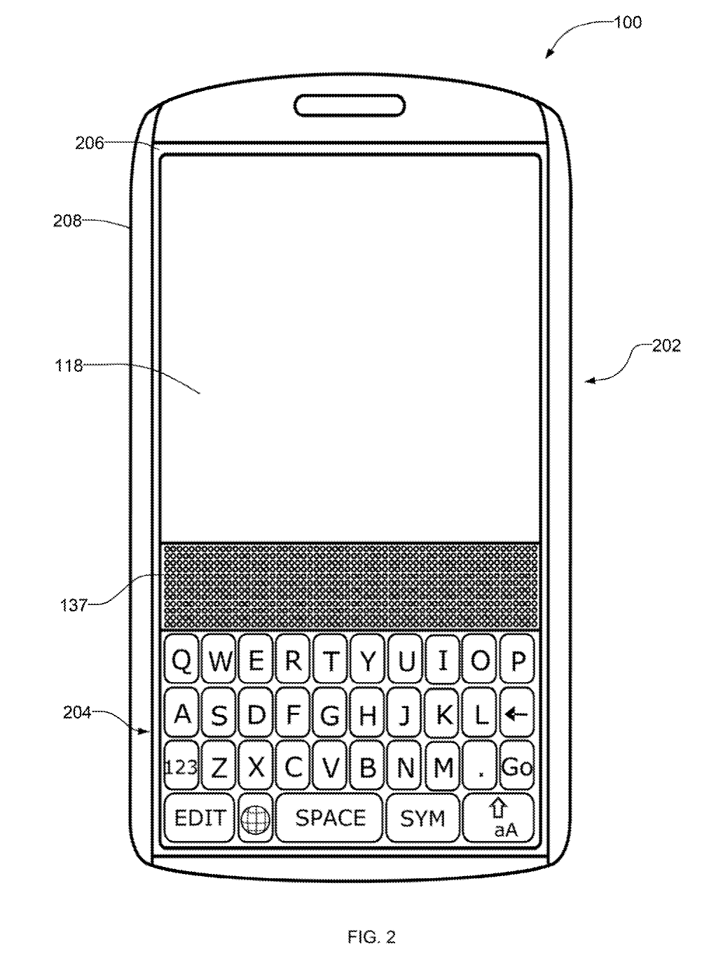

FIG. 2 is a front view of a portable electronic device such as the portable electronic device 100 of FIG. 1. In the example of FIG. 2, the portable electric device 100 is a handheld communication device or mobile phone. As mentioned above, the electronic device 100 may be a data and/or voice-enabled handheld device that may be used to send and receive a message, a voice communication, a textual entry, etc. Referring to FIG. 2, the portable electronic device 100 includes a housing 202 that encloses the electronic or mobile components described above in connection with FIG. 1. For example, the housing 202 encloses the microprocessor 102, the touch-sensitive display 118, a keypad 204 (e.g., a virtual keypad, a physical keypad, etc.), the speaker 128, the microphone 130, the optical sensor apparatus 137, etc. The housing 202 may include a front cover or lid 206 that couples to a frame or base 208 to capture the electronic components within the housing 202. The housing 202 of the illustrated example can be held in one hand by a user of the portable electronic device 100 during data (e.g., text) and/or voice communications.

In the example of FIG. 2, a user interacts with the electronic device 100 via the touch-sensitive display 118 and/or the optical sensor apparatus 137. Additionally or alternatively, in other examples, the electronic device 100 may include a physical key or keypad apparatus. Input detected by the touch-sensitive display 118, a physical key, and/or the optical sensor apparatus 137 may result in execution of to choose commands, execution of application programs, performance of other functions, selection of menu items or icons, scrolling and/or highlighting an icon or image.

In some examples, the optical sensor apparatus 137 may display one or more menu keys and detect selection of the one or more menu keys via a touch-event sensed by the optical sensor apparatus 137 when an input member touches a portion of the optical sensor apparatus 137 associated with the presented key. Although not shown in the example of FIG. 2, the example optical sensor apparatus 137 may have a display to present indicia or graphics representing different (e.g., alphanumeric) character inputs. For example, the one or more character inputs may include function keys such as, for example, an on/off button or call end button, a call send button, a menu button, an escape key, a track pad, etc. In some examples, the optical sensor apparatus 137 replaces known optical navigation modules (e.g., a track pad). In some examples, the optical sensor apparatus 137 may not include the display 210 such that the optical sensor apparatus 137 provides a navigation module (e.g., a track pad) having a relatively high resolution.

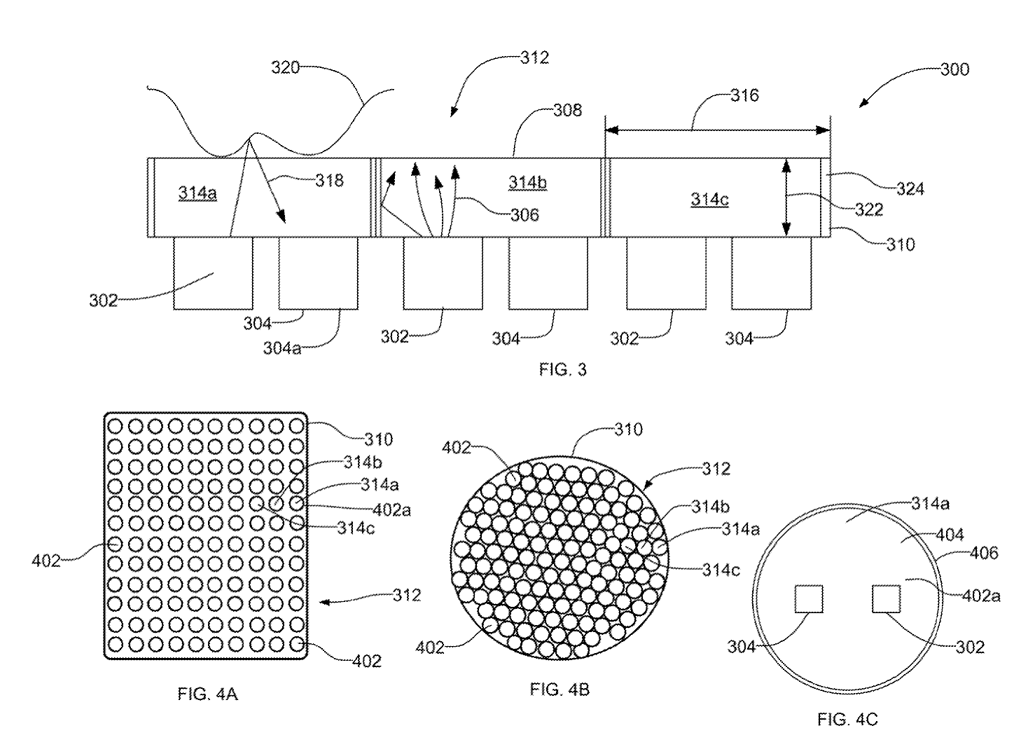

FIG. 3 illustrates a side view of an example optical sensor apparatus 300 that may be used with the example electronic device 100 of FIG. 1 and FIG. 2. The optical sensor apparatus 300 shown in FIG. 3 includes a plurality of optical transmitters or emitters 302 and a plurality of optical receivers or sensors 304. The optical transmitters 302 are arranged to emit light generally in a first direction 306 (e.g., a vertical direction in the orientation of FIG. 3). At least one optical receiver 304 corresponds with one of the optical transmitters 302. The optical transmitters 302 of the illustrated example may be, for example, a liquid crystal display (LCD), one or more light emitting diodes (LEDs), infrared (IR) LEDs, backlighting for an LCD panel, vertical cavity surface emitting laser (Vcsel) panel, a visible laser light, etc. For example, the optical receivers 304 may be optical sensors such as, for example, photodiodes, a photosensors, CMOS (complementary metal-oxide semiconductor) image sensors, CCD (charge-couple device) image sensors, sensor LEDs and/or any other suitable sensors to detect light or detect the presence of an object.

To channel light emitted by the transmitters 302 to a sensing surface 308 and/or to increase a resolution of a display, the example optical sensor apparatus 300 employs an optical guide or light guide 310. The optical guide 310 of the illustrated example is positioned near (e.g., over or on top of) the transmitters 302 and the receivers 304. The optical guide 310 includes a fiber optic array 312 (e.g., a fiber optic array face plate) providing a plurality of optical channels 314a-c arranged to guide the light in the first direction 306 between the transmitters 302 and the sensing surface 308 of the optical guide 310. To prevent the transmitters 302 from emitting light across the adjacent fiber optic material or channels 314a-c (e.g., cross-optical communication or illumination), each of the channels 314a-c is configured to optically isolate at least one of the receivers 304 and/or the transmitters 302 associated with the ones of the channels 314a-c from the receivers 304 and/or transmitters 302 associated with the other ones of the channels 314a-c. As a result, the channels 314a-c of the optical guide 310 can shield the receivers 304 from unwanted stray light that may be present or caused by the adjacent transmitters 302. As shown in the illustrated example of FIG. 3, the optical channels 314a-c are aligned with respective ones of the optical transmitters 302 such that the light emitted is channeled or guided along the optical channels 314a-c in the direction 306 and to the sensing surface 308 of the optical guide 310. Thus, the transmitters 302 illuminate the sensing surface 308. Each of the optical channels 314a-c (e.g., a fiber optic material) of the illustrated example is spaced apart by a distance 316 of approximately between 50 and 100 microns. However, in other examples, the optical channels 314a-c may be spaced apart any suitable distance.

The optical guide 310 may employ a light tube, a collimator and/or the fiber optic array 312. In addition to channeling light to the sensing surface 308, the light tube, collimator or fiber optic array 312 captures light and transports or channels the reflected light to the receivers 304. For example, the optical guide 310 captures and transports light reflected in a direction generally represented by arrow 318 by an input member 320 such as, for example, a user's finger, when the input member 320 is positioned on the sensing surface 308 of the optical guide 310. As a result, light emitted by the transmitters 302 and channeled to the sensing surface 308 is reflected by the input member 320 in the direction of arrow 318 back toward the receivers 304. More specifically, the optical guide 310 enhances or brings an image of the input member 320 (e.g., a user's finger) closer to the receivers 304. In other words, the optical guide 310 focuses, directs or routes light onto the receivers 304 and reduces an effective distance 322 between the receivers 304 (e.g., the viewing plane of the receiver) and the sensing surface 308 (e.g., sensing surface viewing plane). For example, the distance 322 between the sensing surface 308 and the receivers 304 may be approximately between 200-1000 microns. As a result, the optical guide 310 significantly reduces external or unwanted light from traveling or cross-communicating between neighboring or adjacent receivers 304, thereby significantly increasing the accuracy of the image reception by plurality of receivers 304.

As a result, the fiber optic array 312 can concentrate an object on the sensing surface 308 (e.g., the fiber optic array) to the receivers 304 with relatively high accuracy. The fiber optic array 312 positions, channels or transports a detected object positioned on the sensing surface 308 closer to the receivers 304, thereby facilitating or improving the accuracy of the receivers 304 to read or see details of the input member 320 (e.g., fingerprint recognition) without an optical focal system.

Additionally or alternatively, the optical guide 310 employs a cover 324 to provide a protective cover for the optical transmitters 302, the receivers 304 and the fiber optic array 312 when the cover 324 is positioned over or near the optical transmitters 302 and receivers 304. For example, the cover 324 and/or optical guide 310 may be disposed directly on the plurality of optical transmitters 302 and/or the receivers 304. The optical guide 310 may be coupled to the transmitters 302 or receivers 304 via a (e.g., a thin layer) of adhesive. In some examples, a housing (e.g., the housing 202 of FIG. 2) of an electronic device (e.g., the electronic device 200) captures or mounts the cover 324 and/or the optical guide 310 to the electronic device and positions the optical guide 310 relative to the transmitters 302 and the receivers 304 without use of adhesive. The cover 324 also helps separate the channels 314a-c or fiber optic array.

The sensing surface 308 may be a touch pad, a track pad, a mouse and/or other input device(s). For example, an input member may be swiped or glided across the sensing surface 308 of the optical guide 310 to use the optical sensor apparatus 300 as a touch pad. In other examples, the sensing surface 308 may be used for finger gesture recognition, handwriting recognition, navigation, zooming in images, scrolling activities, stylus writing etc. In some examples, the optical sensor apparatus 300 may be used for fingerprint acquisition and/or identification.

In some examples, as described below in greater detail, at least one of the optical transmitters 302 and/or at least one of the optical receivers 304 includes a portion of a display or touch-sensitive display (e.g., a TFT panel, an OLED panel, an Eink panel, an EL panel, etc.). As a result, in the examples in which the optical sensor apparatus 300 employs a display (e.g., a touch-sensitive display), the display may present images of characters or other function keys via the optical guide 310 and/or through the cover 324 and presents images visible via the sensing surface 308. For example, the display may present different characters, symbols, or other function keys in touch-event areas represented by different areas of the sensing surface 308. Thus, the optical sensor apparatus 300 disclosed herein may employ a virtual keypad that can change based on an active application (e.g., a morphing keypad) running on an electronic device. For example, the optical sensor apparatus 300 may present menu keys (e.g., a call key, a call end key) when the electronic device is in a phone application mode. In other examples, the optical sensor apparatus 300 may display a keypad associated with a media player (e.g., play key, pause key, etc.).

Further, the optical guide 310 provides a higher sensing resolution because the optical guide 310 transports light (e.g., reflected light) from the sensing surface 308 to the receiver 304 and the channels 314a-c optically isolates the reflected light 318 toward the receivers 304 associated with the ones of the channels 314a-c. Thus, in some examples, the optical sensor apparatus 300 may be positioned or implemented with a portion of a display or touch-sensitive display. As a result, the display or the touch-sensitive display can provide a first image sensing resolution and the optical sensor apparatus 300 and/or optical guide 310 and/or the cover 324 provides an area having a second image sensing resolution where the second image sensing resolution is greater than the first sensing image resolution.

Although not shown, in some examples, an optical sensor apparatus 300 disclosed herein may also employ a device to provide tactile feedback in response to an object engaging a portion of the sensing surface. The device may include, for example, an electric switch, a dome switch, a piezoelectric actuator, a pressure actuator or sensor (e.g., pressure film), and/or any other suitable device to provide sensing and/or tactile feedback.

FIG. 4A illustrates a plan view of the example optical guide 310. The optical guide 310 of the illustrated example provides the fiber optic array 312 in a rectangular shape. The fiber optic array 312 is composed of a plurality of fiber optics 402 (e.g., fiber optic wires) arranged or bundled in an array forming a planar contact area that provides the sensing surface 308. The ends of the fiber optic material may be bonded, polished and sliced to provide the fiber optic array 312. Thus, the sensing surface 308 may be composed of one or more fiber optic array defined by the channels 314a-c. As shown in FIG. 4A, the fiber optics 402 are arranged in a grid-like pattern (e.g., an x-y grid pattern).

Alternatively, FIG. 4B illustrates a plan view of the optical guide 310 configured in a circular shape. Also, the fiber optics 402 are arranged or positioned in a web-like pattern (e.g., a honeycomb pattern). In other examples, the fiber optic array 312 and/or the optical guide 310 may have an arcuate shape, triangular shape, and/or any other suitable shape(s) and the fiber optics 402 may be positioned in a grid-like pattern, a honeycomb pattern and/or any other suitable pattern(s).

FIG. 4C is an enlarged portion of an example fiber optic 402a of the fiber optic array 312 of FIG. 4A or FIG. 4B. Each of the fiber optics 402 is associated with at least one of the transmitters 302 and one of the receivers 304. More specifically, each of the fiber optics 402 includes a core material 404 (e.g., a material of higher refractive index such as glass) and an outer material or cladding 406 (e.g., a material of lower refractive index). The core material 404 is surrounded, encased or encapsulated by the cladding 406. The transmitter 302 and the receiver 304 are covered by or are in communication with the core material 404 of the fiber optic 402. The cladding 406 confines the light in the core material 404 of the fiber optic 402a by total internal reflection at the boundary between the core material 404 and the cladding 406. Thus, the cladding 406 isolates the light within the respective ones of the channels 314a-c defined by the core material 404.

FIG. 5 illustrates a top view of a portion of the example optical sensor apparatus 300 of FIG. 3. As shown in FIG. 5, the transmitters 302 and the receivers 304 are positioned or formed in grid-like matrix or pattern 500 having x number of rows 502 and y number of columns 504. In the illustrated example, each transmitter and receiver pair 506 is representative of an optical pixel 508 of the optical sensor apparatus 300. For example, each optical pixel 508 may include a transmitter that provides each of a red, blue and green light and a receiver such as a photodiode sensor.

Referring to FIGS. 3 and 5, in operation, the transmitters or light source 302 is activated to propagate light in the direction generally represented by arrows 306 (e.g., upward direction in the orientation of FIG. 3). The channels 314a-c of the optical guide 310 isolate the light from the respective ones of the transmitters 302 and direct the light toward the sensing surface 308 to illuminate the sensing surface 308. As noted above, each of the channels 314a-c isolates or prevents light emitted from the transmitters 302 from illuminating an adjacent pixel 408.

When the input member 320 is positioned on the sensing surface 308, the reflected light 318 is channeled or transported to the receiver 304a associated with the pixel 508 or channel 314a (e.g., an area) of the sensing surface 308 engaged by the input member 320. Because the channel 314a isolates the light relative to the other adjacent channels 314b-c of the sensing surface 308, the optical sensor apparatus 300 disclosed herein increases the resolution and/or accuracy for detection of the input member 320. In other words, the channels 314a-c prevent scattering of light 318 reflected by the input member 320 from reaching the other receivers 304 that are not associated with a selected area associated with a touch-event provided by the input member 320.

The receiver 304a generates an electrical signal in response to the input member 320 being placed on the channel 314a of the sensing surface 308 associated with the receiver 304a. A control circuit (e.g., a grid-like sensing circuit) detects the position of the input member 320 on the sensing surface 308 and activates a command representative of an action or character associated with the sensed position (e.g., the channel 314a). For example, a control circuit (not shown) associates the signal generated by the receiver 304a in response to a touch-event with a particular key, function and/or image presented in the touch-event area represented by channel 314a of the optical guide 310. For example, the processor 102 of FIG. 1 may process the location of the X and Y coordinates representative of the row 502 and column 504 of the activated receiver 304a to detect the particular key or command associated with the receiver 304a. For example, the optical sensing apparatus 300 may have a network of traces composed of copper, gold and/or any other material for conducting electricity disposed on, for example, a flexible printed circuit board or an Indium Tin Oxide film or sheet. The processor 102 may include signal-mapping detection software to enable detection of a location of the receiver 304a over a given area of the sensing surface 308 of the optical guide 310.

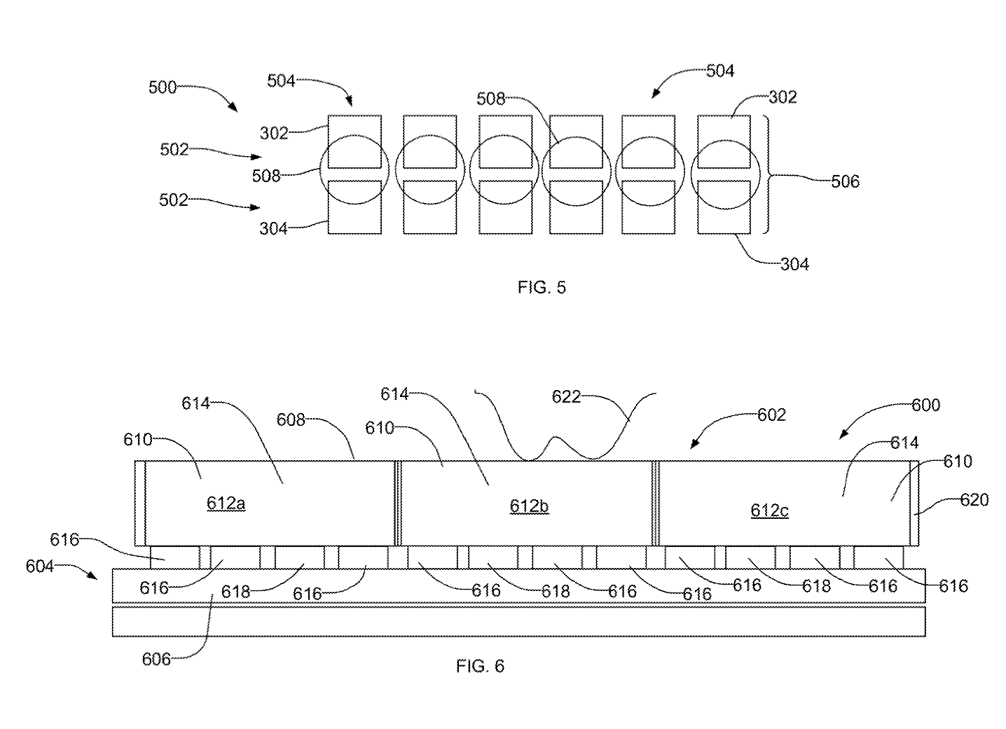

FIG. 6 illustrates a cross-sectional view of another example optical sensor apparatus 600 disclosed herein that may be used to implement the electronic device 100 of FIG. 1. The optical sensor apparatus 600 of the illustrated example includes an optical guide or fiber optic array 602 positioned above or over a liquid crystal display substrate assembly 604 (LCD). For example, the example optical sensor apparatus 600 of FIG. 6 employs an LCD panel 606 having an optical sensor or receiver (e.g., an embedded optical sensor, a photo sensor, etc.) and the optical guide 602 to provide both an LCD display with high resolution navigation functionality and/or to provide a morphing virtual keypad. Additionally or alternatively, similar to the optical guide 310 of FIG. 3, the optical sensor apparatus 600 of the illustrated example provides high resolution navigation functionality (e.g., x-y navigation) to provide, for example, a track pad.

In this example, the optical guide 602 provides a sensing surface 608 having a fiber optic 610 for each LED segment 612a-c. For example, each LED segment 612a-c may provide an optical pixel 614 of the optical sensor apparatus 600. Thus, the LED segments 612a-c may be positioned across the LCD substrate assembly 604 in a grid-like pattern or matrix (e.g., an x-y grid). Each LED segment 612a-c includes three light-emitting diodes (LEDs) 616 providing red, green and blue light to allow color mixing for each optical pixel 614, essentially producing color image to the external viewer. Each LED segment 612a-c also includes an optical sensor 618 to detect light reflected in the LED segment 612a-c by an object 622. Additionally, the optical sensor 618 of the illustrated example can detect at least red, blue and green light independently. Each of the LED segments 612a-c is segregated or optically isolated from the other adjacent LED segments 612a-c to provide direct light transport from the LEDs 616 to the sensing surface 608. Thus, the LEDs 616 are employed to illuminate the object 622 in engagement with the sensing surface 608 of the fiber optics 610. Thus, no external light source may be needed to illuminate the sensing surface 608.

The LCD panel 606 presents a detailed image that can be presented to the sensing surface 608 through the fiber optic 610 and/or a cover 620 of the optical guide 602. The detailed image may be, for example, a character or a function key associated with a virtual keypad of an electronic device. The optical sensor 618 generates a signal in response to a touch-event provided to the LED segments 612a-c by the object 622. More specifically, the object 622 reflects light toward the optical sensors 618 and the optical sensors 618 generate an electrical signal when the reflected light is detected. Each of the LED segments 612a-c optically isolate the optical sensor 618 associated with one of the LED segments 612a-c from the other optical sensors 618 associated with the other ones of the LED segments 612a-c. In operation, a user may engage the fiber optic 610 or sensing surface 608 to activate a function or key representative of an image or character projected through the LED segments 612a-c by the LCD panel 606.

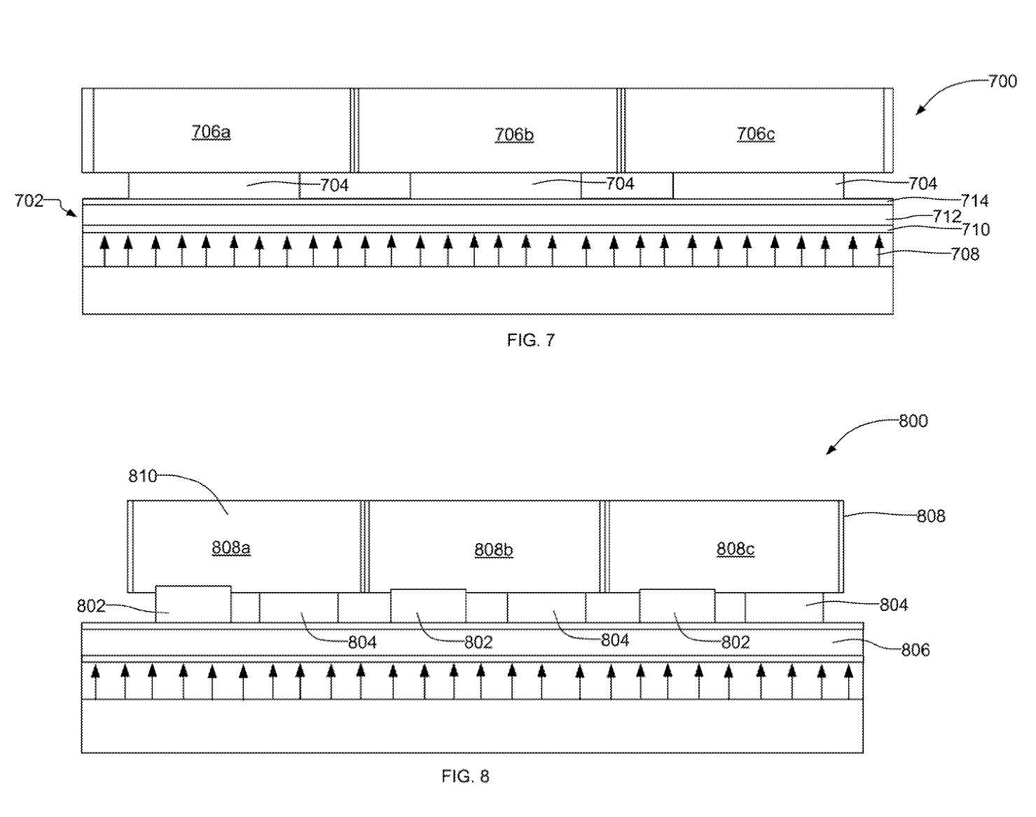

FIG. 7 illustrates yet another example optical sensor apparatus 700 disclosed herein. The example optical sensor apparatus 700 employs an LCD panel 702 having optical sensors 704 associated with respective fiber optics 706a-c positioned over or adjacent the LCD panel 702 and the optical sensors 704. The LCD panel 702 is provided with a backlighting 708 (e.g., a white light provided by LEDs, etc.) that projects through a first polarizer 710, which directs or orients the light through a liquid crystal portion 712, and a second polarizer 714 that projects or presents a detailed image. The LCD panel 702 may include a RGB filter to provide color mixing when presenting an image. Additionally, the fiber optics 706a-c are illuminated via the backlighting 708 of the LCD panel 702. An object positioned over one of the fiber optics 706a-c reflects the backlighting toward the optical sensors 704. The fiber optics 706a-c channels the reflected light toward the respective optical sensor 704 associated with the fiber optics 706a, 706b or 706c engaged by the object.

FIG. 8 illustrates yet another example optical sensor apparatus 800 disclosed herein. The example optical sensor apparatus 800 employs a plurality of optical transmitters or emitters 802 and a plurality of sensors 804. As shown, the optical transmitters 802 and the sensors 804 are positioned over an LCD substrate or panel 806. However, in other examples, the LCD panel 806 may not be included. In this example, the transmitters 802 are infrared (IR) LEDs. An optical guide or fiber optic array 808 is positioned over the IR LEDs 802, the sensors 804 and the LCD panel 806 such that a fiber optic 808a-c is associated with one of the IR LEDs 802 and one of the sensors 804. In other words, an optical pixel 810 of the optical sensor apparatus 800 is provided by an IR LED 802a, a sensor 804a and the fiber optic 808a. Similar to the above examples, the fiber optic 808a optically isolates the infrared LED light from an adjacent fiber optics 808b and/or 808c and projects the infrared light to a sensing surface 812 defined by the fiber optic array 808. As a result, no lighting is visible to the naked eye when the infrared LEDs 802 are employed. In particular, the infrared LEDs 802 provide high resolution navigation functionality.

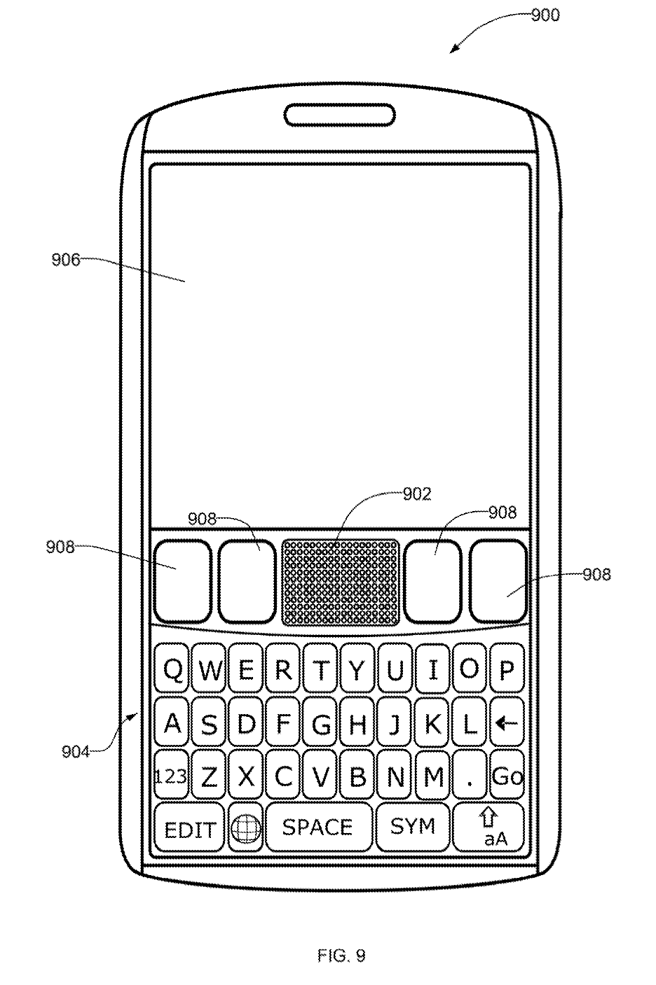

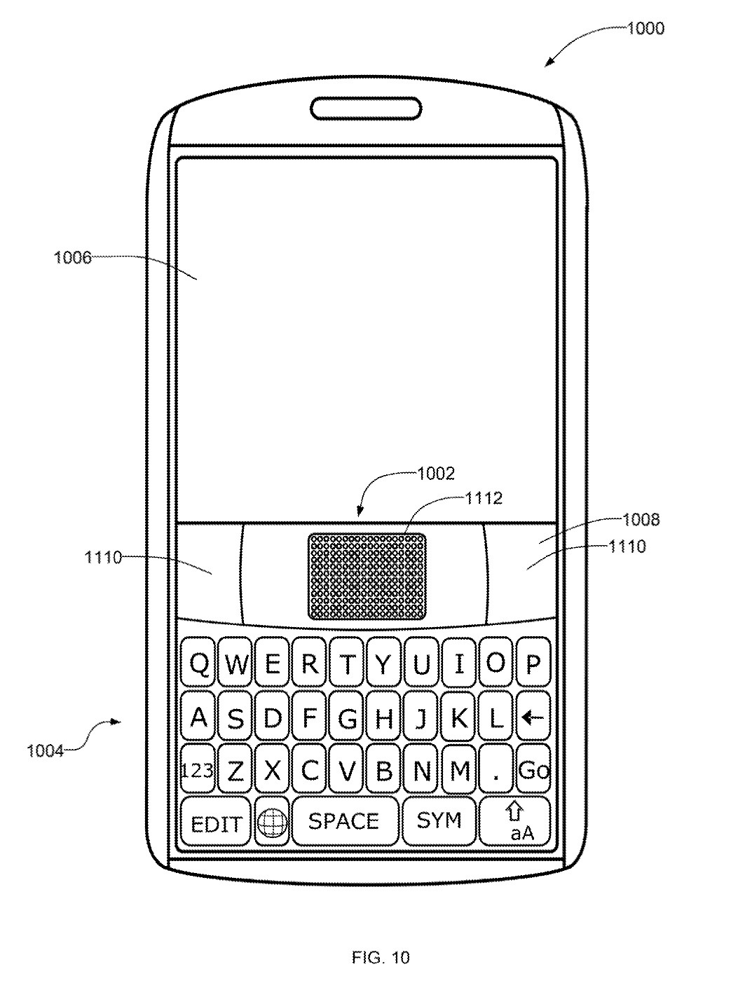

FIG. 9 illustrates an example electronic device 900 implemented with an example optical sensing apparatus 902 in accordance with the teachings disclosed herein. The example optical sensing apparatus 902 of the example electronic device 900 of FIG. 9 is positioned between a keypad 904 and a display 906 (e.g., a touch-sensitive display). Further, function keys 908 (e.g., menu key, a call key, a hang-up key, etc.) are positioned adjacent the optical sensor apparatus 902. The optical sensor apparatus of the illustrated example is configured to provide a high resolution track pad to provide navigation functionality.

FIG. 10 illustrates an example electronic device 1000 implemented with an example optical sensing apparatus 1000 in accordance with the teachings disclosed herein. In this example, the optical sensor apparatus 1002 is positioned between a keypad 1004 and a display 1006. In the illustrated example, the optical sensor apparatus 1002 is configured to provide a morphing keypad 1008. For example, the morphing keypad 1008 can provide image or characters representative of the functions keys 908 of the electronic device 900 of FIG. 9. A track pad 1010 is positioned between the morphing keypad 1008.

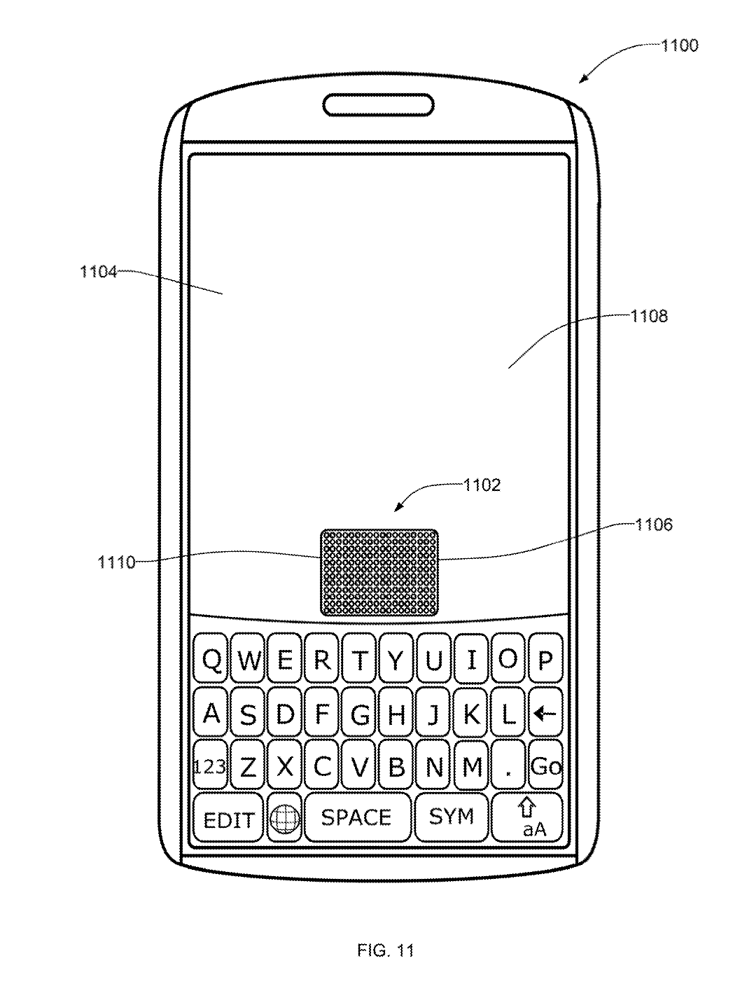

FIG. 11 illustrates an example electronic device 1100 implemented with an example optical sensing apparatus 1102 in accordance with the teachings disclosed herein. In the illustrated example, the optical sensor apparatus 1102 is embedded or provided in a display 1104 (e.g., a touch sensitive display). More specifically, because the optical sensor apparatus 1102 employs an optical guide (e.g., the optical guide 310 and a cover 324 of FIG. 3) positioned over at least a portion 1106 of the display 1104, the electronic device 1100 of the illustrated example provides a first image sensing resolution 1108 and a second image sensing resolution 1110 such that the second image sensing resolution 1110 is higher than the first image sensing resolution 1108 due to the optical guide. Information is displayed on the touch-sensitive display 1104 through the optical guide or cover. Thus, information displayed through the optical guide has a higher resolution than information that is not displayed through the optical guide. In some examples, the optical guide is positioned over an entire viewing area of the display 1104 to provide a higher resolution to the entire viewing area.

The methods described herein may be carried out by software executed, for example, by the processor 102. Coding of software for carrying out such a method is within the scope of a person of ordinary skill in the art given the present description. A computer-readable medium having computer-readable code may be executed by at least one processor of the portable electronic device 100 to perform the methods described herein.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. An optical touch sensor comprising:
a plurality of optical transmitters arranged to emit light generally in a first direction;
a plurality of optical receivers, wherein at least one optical transmitter corresponds with each of the plurality of optical receivers;
an optical guide comprising a plurality of optical channels arranged in the first direction, wherein the optical guide provides a protective cover for the plurality of optical transmitters and the plurality of optical receivers.

2. The optical touch sensor of claim 1, wherein the plurality of optical channels are aligned with the plurality of optical transmitters such that the light is emitted along the optical channels.

3. The optical touch sensor of claim 1, wherein the optical guide is disposed directly on the plurality of optical transmitters.

4. The optical touch sensor of claim 1, wherein the plurality of optical transmitters comprises a liquid crystal display.

5. The optical touch sensor of claim 1, wherein the plurality of optical transmitters comprises a light-emitting diode display.

6. The optical touch sensor of claim 1, wherein the plurality of optical transmitters comprises a backlight for a liquid crystal display.

7. The optical touch sensor of claim 1, wherein an optical navigation device comprises the plurality of optical receivers.

8. The optical touch sensor of claim 1, wherein the plurality of optical receivers detects a fingerprint.

9. An optical navigation device comprising:
a display arranged to emit light generally in a first direction;
a plurality of optical receivers disposed within the display, wherein at least one pixel of the display corresponds with at least one of the optical receivers;
an optical guide comprising a plurality of optical channels arranged in the first direction, wherein the optical guide provides a protective cover for the display and the plurality of optical receivers.

10. The optical navigation device of claim 9, wherein the plurality of optical channels are aligned with the at least one pixel such that the light is emitted along the optical channels.

11. The optical navigation device of claim 9, wherein the optical guide is disposed directly on the display.

12. The optical navigation device of claim 9, wherein the display comprises a liquid crystal display.

13. The optical navigation device of claim 9, wherein the display comprises a light-emitting diode display.

14. The optical navigation device of claim 9, wherein the display comprises a backlight for a liquid crystal display.

16. The optical navigation device of claim 9, wherein the plurality of optical receivers detects a fingerprint.

17. A device comprising:
a touch-sensitive display comprising at least one optical sensor and at least one optical emitter, the touch-sensitive display having a first image sensing resolution;
a cover disposed over at least a portion of the touch-sensitive display and isolating the at least one optical sensor and the at least one optical emitter from other optical sensors, resulting in an area having a second image sensing resolution higher than the first image sensing resolution.

18. The device of claim 17, wherein isolating the at least one optical sensor and the at least one optical emitter from the other optical sensors comprising optically isolating the at least one optical sensor and the at least one optical emitter from the other optical sensors.

19. The device of claim 17, wherein the cover is disposed over substantially the entire display.

20. The device of claim 17, wherein the cover comprises an optical fiber material.

21. The device of claim 17, wherein information is displayed on the touch- sensitive display through the optical cover.

22. The device of claim 21, wherein information displayed through the cover has a higher resolution than information that is not displayed through the cover.
